(19) United States
(12) Patent Application Publication
(10) Pub. No.: US 2004/0004362 A1
(43) Pub. Date: Jan. 8, 2004

(54) Magnetic grapple

(76) Inventor: Dan Love, New Middletown, OH (US)

Correspondence Address: BARNES & THORNBURG, P.O. BOX 2786, CHICAGO, IL, 60690-2786, US

(21) Appl. No.: 10/188,708

(22) Filed: Jul. 2, 2002

(51) Int. Cl. B66C 1/04; B66C 3/04

(52) U.S. Cl. 294/3; 294/65.5

(57) ABSTRACT

A magnetic grapple is disclosed. The magnetic grapple is comprised of a body with a magnetic portion, at least a pair of tines having magnetic portions and a magnetic transfer coupler in communication with the body and the tines. The magnetic grapple is capable of generating at least one magnetic field between the tines and the body for attracting ferrous material into the grapple.

### BACKGROUND

The present disclosure relates to material handling devices which might find utility, for example in the scrap material industry.

Generally in the scrap material industry there are several ways to lift and move material from one location to another. The two most common material handling devices are grapples and electromagnets. Both of these devices are effective and at the same time have unique disadvantages.

Numerous scrap handling grapples (“grapples”) are known in the prior art. Such devices are used for gathering and moving material, often of irregular shape. For example, grapples may be used to gather scrap metal into a pile and then transport it to another location, such as for further processing. Examples of various grapples are shown in U.S. Pat. Nos. 762,759; 2,850,189; and 1,590,020; and.

Grapples of this sort often include a plurality of tines that may be moved to open the grapple. The open grapple may then be placed on top of the material to be gathered and the tines closed about the material so as to contain it. The grapple can then be moved to another location where the tines are opened and the materials are released.

A typical grapple is an efficient way to move scrap metal as long as the grapple is handling material in a deep pile. A grapple can dig into the pile and remove a large volume of material. The material to be handled can be mixed ferrous or non-ferrous material with which the grapple works equally well. When a pile of scrap material becomes shallow, as the movement of material nears completion, the grapple loses some of its efficiency and may dig into the surface upon which the scrap material is resting. This of course causes damage to the surface and also causes the grapple to pick up unwanted material such as dirt or stones.

Additionally, as the material to be lifted and moved by the grapple is often of irregular size and shape and because the tines of the grapple, even when closed, do not form a complete enclosure, material that is initially gathered into the grapple may occasionally fall out during transport. This may result in the deposit of material where it is not desired, which increases the amount of work to be performed, as the material that has fallen from the grapple must be gathered at a later point.

Further, where the pile of material is located near vertical surfaces such as the walls of a waste disposal dumpster or near a retaining wall in a scrap yard, the grapple has a difficult time handling material located near the walls. Any material that remains, which the grapple can not handle must either be abandoned or removed manually.

For example, in an application where scrap material is to be removed from a rail car, a grapple would be attached to a crane. The grapple would then be moved into contact with the material contained within the rail car and operated closed to obtain a volume of scrap material. As this process continues, the material remaining in the rail car will decrease. Eventually, only a small amount of material will remain, typically a thin layer resting on the bottom of the rail car and small piles located in the corners of the rail car. The grapple will be unable to handle this remaining material.

To complete the removal of all the material from the rail car, the crane operator would need to manually remove the remaining material, remove the grapple from the crane hoist and replace it with a material handling electromagnet, or abandon the material in the rail car. All three of these options increase the time required to remove the material as well as the cost associated with such removal.

The other material handling device generally applied in the scrap material industry is the material handling electromagnet (“electromagnet”). Electromagnets work differently than grapples. Whereas a grapple closes around material in order to move it, an electromagnet need only be brought into close proximity to the material to move it. Thus, a major advantage of an electromagnet is that the electromagnet will attract any ferrous scrap material up to meet the magnet. An electromagnet is an efficient device for handling material when the material is not piled deeply. Also, an electromagnet is particularly suited for handling material located near vertical surfaces or near corners of containers.

Another use for which electromagnets are particularly suited is when sorting of different types of material is required. In many cases, a scrap material facility may receive a load of material which contains a combination of ferrous and nonferrous metal. It is often desirable to sort the material into separate containers for processing based on whether or not the material contains ferrous material, such as iron or steel. In such a case an electromagnet may be passed over a collection of mixed material. Any ferrous material would then be pulled from the collection of material and become temporarily affixed to the surface of the electromagnet leaving the non-ferrous material behind.

One principle drawback of the electromagnet is limited lifting ability. The lifting ability of an electromagnet is derived from applying electric current to a magnetic structure. When an electrical current is applied, heat is generated. As an electromagnet heats up, it begins to loose some of its magnetic capability and thus reduces its lifting capacity. This problem is known, and as a result most electromagnet specifications take into account this problem by providing a limited duty cycle.

An electromagnet's lifting ability is not only limited as to time, but also as to volume. An electromagnet, relying only on magnetic forces to handle material, typically has a much worse lift to weight ratio than a grapple of comparable size. For instance, an electromagnet typically weighs up to 50% more than a grapple which can lift the same volume of material. As such, grapples typically can move a greater volume of material than electromagnets.

In addition to limited lifting ability, electromagnets can only attract ferrous material. Therefore, an electromagnet would be useless in an application where non-ferrous material needed to be handled.

The present disclosure envisions a hybridized magnetic grapple comprising a body, at least a pair of tines, magnetic portions on the body and the tines, and an electrically conductive coupler connecting the magnetic portion on the body with the magnetic portions on the tines. Each of the individual tines are attached to the body by a pivot end such that the terminal end of each tine opposes one another. In addition, a second pair of tines may be positioned perpendicular relative to the first pair of tines.

The present disclosure also envisions a hybridized magnetic grapple in which a unitary magnetic field is generated by the body, in combination with the tines. An electrically conductive coupler and a magnetic transfer coupler allow the magnetic portion of the body to work in combination with the magnetic portions of the tines in an electrical series.

The present disclosure also envisions controllers for both the grapple and the electromagnet. The controllers allow for selective control of the magnetic portions of the tines separately from the magnetic portion of the body, or allow the magnetic portions of both the body and the tines to operate in combination with one another.

The present disclosure provides a more efficient apparatus and method of handling material in the scrap material industry by effectively combining electromagnetic attributes with mechanical grapple attributes without sacrificing valuable space within the grapple. The present disclosure contemplates a hybridized magnetic grapple which works more efficiently with a large volume of material in a deep pile, while retaining the capability of magnetically drawing ferrous scrap up into the grapple. The combination of magnetic and mechanical attributes of the present disclosure allows for thorough cleaning and removal of scrap material without unwanted contamination from inadvertent removal of dirt and rock. Further, the present disclosure allows for sorting of ferrous scrap material from nonferrous scrap material and the additional ability to handle the non-ferrous scrap material after sorting.

Additional features will become apparent to those skilled in the art upon consideration of the following detailed description of drawings exemplifying the best mode as presently perceived.

### BRIEF DESCRIPTION OF DRAWINGS

FIG. 1 is an enlarged perspective view a hybridized magnetic grapple;

FIG. 2 is a cross-sectional view of the hybridized magnetic grapple of FIG. 1 in a partially closed position showing a magnetic portion on the body and a magnetic portion on a pair of tines;

FIG. 3 is a cross-sectional view of the hybridized magnetic grapple of FIG. 1 in an open position showing a magnetic field between a tine and the magnetic portion of the body;

FIG. 4 is a cross-sectional view of the hybridized magnetic grapple of FIG. 1 showing the magnetic field in the partially closed position;

FIG. 5 is a cross-sectional view of an alternative embodiment of the hybridized magnetic grapple showing multiple magnetic fields of similar orientation.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

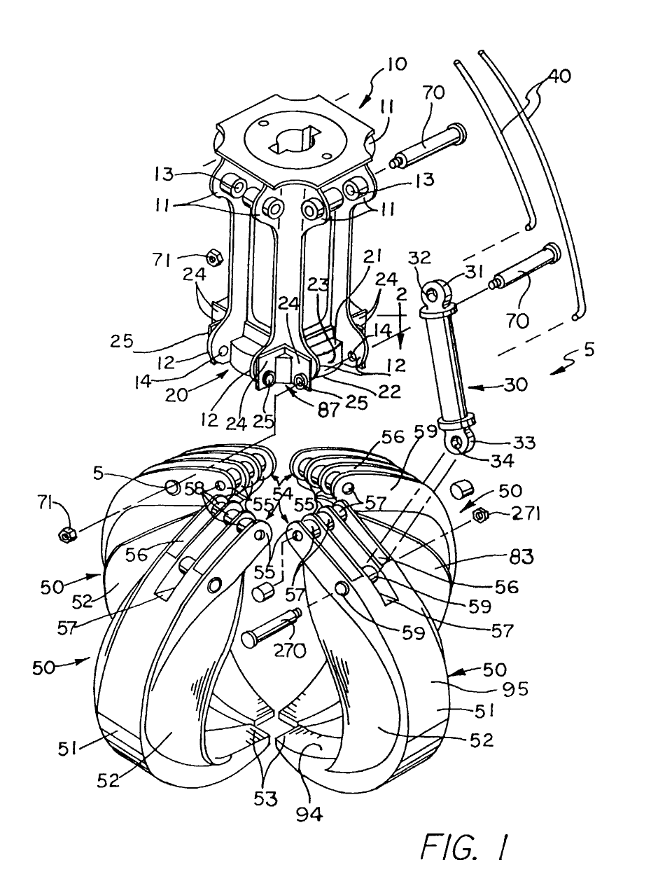

FIG. 1 is an enlarged perspective view of a hybridized magnetic grapple 5. The hybridized magnetic grapple 5 generally comprises a head assembly 10, ferrous body 20, cylinders 30, hoses 40, a plurality of tines 50 and magnetic coil 60.

A head assembly 10 provides a support means for tines 50 and includes a plurality of top ears 11 and bottom ears 12 spaced thereabout in pairs. Top ears 11 each include a hole 13 therethrough. Each bottom ear 12 includes a hole 14 therethrough. Top ears 11 and bottom ears 12 are used to secure cylinders 30 and tines 50, respectively, to head assembly 10 as described below.

Ferrous body 20 is generally located within the space defined by bottom ears 12 and includes a top surface 21, a bottom surface 22 and a continuous side surface 23. A plurality of ears 24 extend from ferrous body 20 and are arranged in pairs spaced evenly about ferrous body 20. One pair of ears 24 corresponds to each pair of bottom ears 12. Ears 24 each include a hole 25 therein. Holes 25 lie along the same axis as holes 14 in the corresponding pair of bottom ears 12.

Each cylinder 30 includes a top ear 31 having a hole 32 therein and a bottom ear 33 having hole 34 therein. Top ear 31 is placed between a pair of corresponding top ears 11 on head assembly 10 and a bolt or pin 70 is inserted through holes 13 and 34 and secured with a nut 71. In this manner, one end of cylinder 30 is secured to head assembly 10. Although only one cylinder 30 is shown, four would be used for the grapple shown, one for each tine 50. Hoses 40 are connected at one end to cylinders 30 and at the other end to a source of hydraulic fluid, as is known in the art, to operated cylinders 30.

Each tine 50 provides a grasping means and is a generally curved member, including a magnetic portion 51, non-magnetic portion 83, an outer skin 52, an interior surface 94, an exterior surface 95, a terminal end 53 and a pivot end 54. At pivot end 54, each tine 50 is separated into a plurality of arms 55 separated by two outer slots 56 and one inner slot 57. Note that inner slot 57 in each tine 50 extends below the two outer slots 56. A hole 58 extends through each arm 55 at pivot end 54 of tines 50 and is in communication with slots 56 and 57. A second hole 59 extends through each tine 50 and is in communication with at least inner slot 57. Magnetic portion 51 of tines 50 are preferably constructed from a 1020 steel. Outer skin 52 and non-magnetic portion 83 are preferably constructed from a nonferrous material.

Tines 50 are pivotally secured to head assembly 10 by positioning a pair of lower ears 12 within outer slots 56 in a tine 50 and inserting a bolt pin or other fastening means 70 through holes 57 and 14 and securing with a nut or other suitable fastener 71. Bottom ear 33 of a cylinder 30 is inserted into inner slot 57 of tine 50 and secured thereto by inserting a bolt 270 through second holes 59 and hole 34 and securing with a nut 271. By attaching tines 50 to head assembly 10 a means for movably coupling the tines 50 or a grasping means to the head assembly 10 or a supporting means is provided.

When cylinders 30 are pressurized to extend them by a controller 92, bottom ears 33 will bear against the bolts or pins joining them to tines 50 and cause tines 50 to pivot inwardly. When cylinders 30 are depressurized to retract them by controller 92, top ears 31 will pull on bolts or pins 70 joining them to tines 50, thereby opening tines 50.

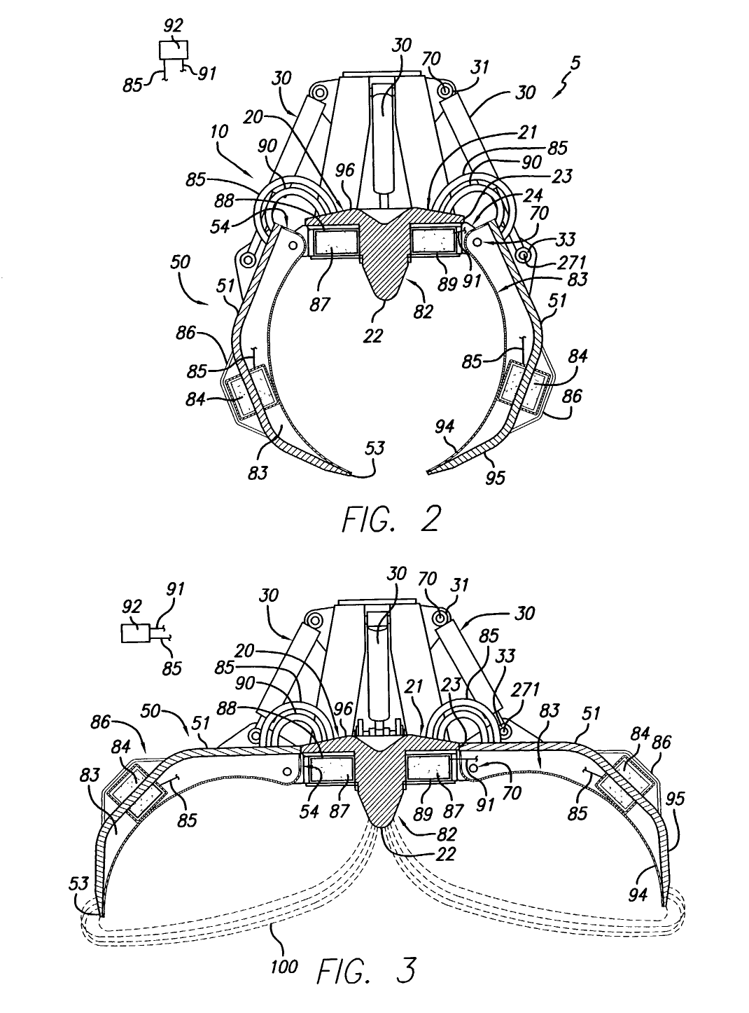

Turning to a magnetic component of the hybridized magnetic grapple 5, FIG. 2 shows tines 50 with a tine magnetic coil 84. Tine magnetic coil 84 is an electromagnetic winding that, when electric current is applied, magnetically charges the tine 50. The tine magnetic coil 84 is shown wound around magnetic portion 51 of tines 50, which forms the core of tine magnetic coil 84. A tine coil shield 86 may be provided to protect tine magnetic coil 84 by at least partially encasing tine magnetic coil 84.

Ferrous body 20 is shown in FIG. 2 in communication with a body magnetic coil 87 having a superior surface 88 and an inferior surface 89. In a preferred embodiment, ferrous body 20 flangedly engages superior surface 88 of body magnetic coil 87. The bottom surface 22 of ferrous body 20 is dimensioned to define a protrusion 82 which extends through body magnetic coil 87 and into the area proximate the inferior surface 89 which is further defined by tines 50. The protrusion 82 of bottom surface 22 may be dimensioned to extend far enough into the area defined by the tines 50 that when the tines 50 are in an open position, material may contact the protrusion 82.

It is contemplated that ferrous body 20 may be at least partially surrounded by body cover 96 in order to provide some degree of protection. Further, ferrous body 20 and magnetic coil 87 may be of unitary construction.

A magnetic transfer coupler 90 is provided to couple ferrous body 20 to magnetic portion 51 of tines 50. It is contemplated that magnetic transfer coupler 90 may take the form of wire rope, steel cable, or any other suitable material for transferring magnetic energy known to those of skill in the art. By coupling ferrous body 20 to magnetic portion 51 of tines 50, body magnetic coil 87 and tine magnetic coil 84 may work in combination with one another, for example in an electrical series.

As shown in FIG. 3, a magnetic field 100 is generated when electric current is applied in response to a signal from controller 92 to tine magnetic coil 84 over a line 85, and body magnetic coil 87 over a line 91. Through these magnetic generating means the polar orientation of magnetic field 100 is such that magnetic north is on terminal end 53 of tines 50 and magnetic south is on the bottom surface 22 of ferrous body 20.

The generation of magnetic field 100 with the above described polar orientation is accomplished by magnetic transfer coupler 90 causing body magnetic coil 87 and tine magnetic coil 84 to operate in electrical series with one another. The polar orientation of magnetic field 100 will cause a material containing ferrous particles to be drawn from terminal end 53 of tines 50 towards bottom surface 22 of ferrous body 20.

It is contemplated that the polarity of magnetic field 100 may be reversed.

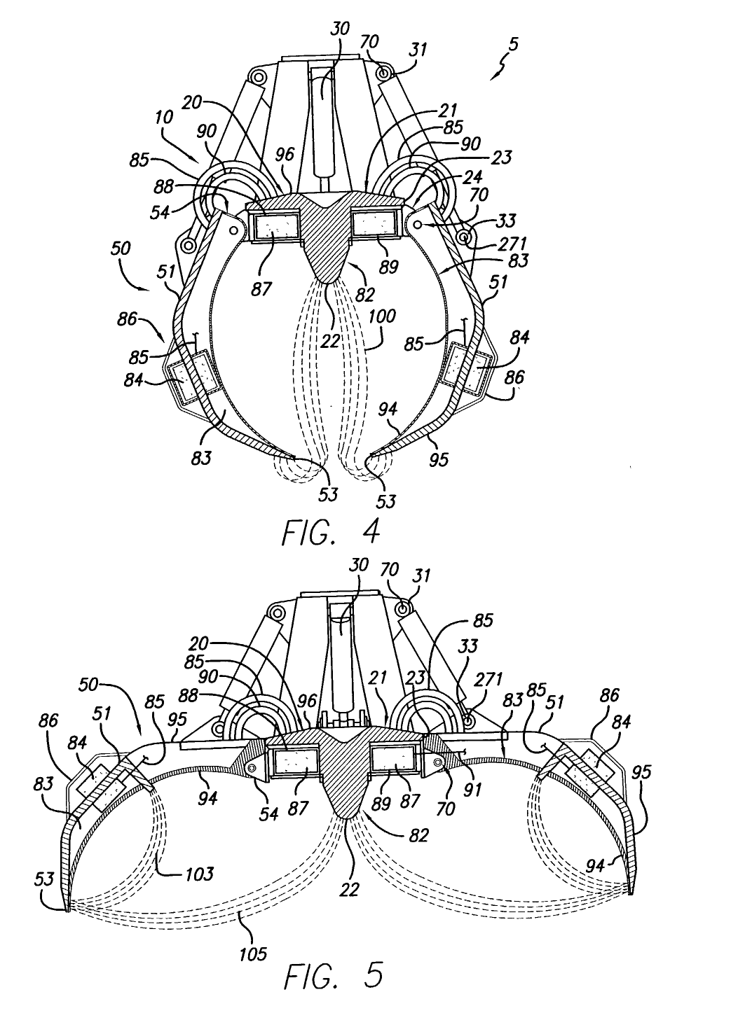

FIG. 4 shows the relative orientation of magnetic field 100 after controller 92 has pressurized cylinders 30 thereby operating tines 50 closed. As terminal end 53 of tines 50 move from an open position shown in FIG. 3 downwardly to a closed position as shown in FIG. 4, the magnetic field 100 changes from a roughly horizontal orientation to a roughly vertical orientation.

By operating tines 50 from an open position as shown in FIG. 3 to a closed position as shown in FIG. 4, magnetic field 100 has changed shape from a relatively wide magnetic field of shallow vertical depth, to a magnetic field of narrow width and greater depth. This ability to change the shape of magnetic field 100 is advantageous for drawing material into the hybridized magnetic grapple 5.

For example, a wide magnetic field may be generated as the hybridized magnetic grapple 5 is brought into contact with material. Then, controller 92 may be activated to close tines 50. As the tines 50 close around material, magnetic field 100 is elongated and material is drawn towards ferrous body 20. Tines 50 thus have more space to mechanically engage material.

In addition to greater space to mechanically engage material, a further advantage of the combination of the magnetic properties and the mechanical properties of the hybridized magnetic grapple 5 is that the combined magneto-mechanical forces yield an improved material handling ability.

FIG. 5 shows an alternative embodiment of the hybridized magnetic grapple 5. In this embodiment, magnetic portion 51 can be seen along both the interior surface 94 and the exterior surface 95 of tine 50. The magnetic portion 51 which is closest to exterior surface 95 terminates into magnetic portion 51 which is closest to interior surface 94 proximate to tine magnetic coil 84. In this orientation, there is no magnetic portion 51 associated with the area of exterior surface 95 of tine 50 extending from an area proximate to tine magnetic coil 84 to pivot end 54.

It is contemplated that magnetic portion 51 closest to outer surface 95 may terminate into magnetic portion 51 closest to interior surface 94 at any location along the tine 50.

As a result of the placement of magnetic portion 51, a plurality of magnetic fields 100 are generated when electric current is applied in response to a signal from controller 92 to tine magnetic coil 84 over line 85, and body magnetic coil 87 over line 91.

A tine magnetic field 103 is generated having a polar orientation such that magnetic north is on terminal end 53 of tines 50 and magnetic south is on interior surface 94 of tines 50 proximate to tine magnetic coil 51. A tine-body magnetic field 105 is also generated. The polar orientation of the tine-body magnetic field 105 is such that magnetic north is on terminal end 53 of tines 50 and magnetic south is on the bottom surface 22 of ferrous body 20.

The alternative embodiment shown in FIG. 5 results in tine magnetic field 103 and tine-body magnetic field 105 sharing terminal end 53 as a common magnetic north point. As a result of the similarly oriented polarity of magnetic fields 103, 105, a material containing ferrous particles will be drawn from terminal end 53 of tines 50 towards either interior surface 94 of tines 50 or towards bottom surface 22 of ferrous body 20 depending on whether tines 50 are in an open position as shown in FIG. 5 or a closed position as shown in FIG. 4. It is contemplated that some material may be drawn to both interior surface 94 and bottom surface 22 regardless of whether tines 50 are in an open or closed position.

In an open position, tine magnetic field 103 is stronger than tine body magnetic field 105. The relative power of the two magnetic fields 103, 105 is due to the distance between terminal end 53 and bottom surface 22. As a result of the relative strengths of the two magnetic fields 103, 105, a majority of ferrous material is attracted to the stronger tine magnetic field 103. This results in material collecting along interior surface 94 of tines 50 when the hybridized magnetic grapple 5 is in an open position.

When the hybridized magnetic grapple 5 is in a closed position, the relative strengths of the two magnetic fields 103, 105 reverse and tine body magnetic field 105 is stronger than tine magnetic field 103. This is due to a decreased distance between terminal end 53 and bottom surface 22. As a result, when the hybridized magnetic grapple 5 is in contact with material in an open position and is then operated from an open position to a closed position by an operator, the relative strengths of magnetic fields 103, 105 switch.

During the closing of the hybridized magnetic grapple 5, a point is reached when the relative strengths of magnetic fields 103, 105 switch. When that point is reached, material that was initially attracted to interior surface 94 by the tine magnetic field 103 will then move further up into the hybridized magnetic grapple 5 towards bottom surface 22. This occurs because the tine body magnetic field 105 is now stronger than the tine magnetic field 103.

It is contemplated that the polarity of magnetic fields 103 and 105 may be reversed.

It is further contemplated that the hybridized magnetic grapple 5 will be attached to a hoist, for example a crane. The hoist will allow the hybridized magnetic grapple 5 to be moved to a location proximate to material to be handled. After material is gathered, the hoist will allow the hybridized magnetic grapple 5 to move to a separate location for depositing the gathered material.

Although these illustrative embodiments have been shown and described in detail, it should be understood that the same is to be taken by way of example only and not by way of limitation. Numerous changes can be made to the illustrative embodiments without removing the resulting structure from the scope thereof. For example, tine magnetic coil 84 may be present on less than all tines 50 of hybridized magnetic grapple 5. Ferrous body 20 can be made in any desired shape. Any number of tines can be utilized and although they are preferably spaced evenly about the ferrous body 20, they do not have to be. The present disclosure can also be utilized with tines and head assemblies of configurations different from those illustrated.

While a preferred embodiment of the disclosure is shown and described, it is envisioned that those skilled in the art may devise various modifications and equivalents without departing from the spirit and scope of the disclosure as recited in the following claims.

We claim:

1. A magnetic grapple comprising:
a body;
a magnetic portion on the body;
at least one pair of tines having a pivot end pivotally attached to the body and a terminal end extending from the body;
at least one magnetic portion on at least one tine of the at least one pair of tines; and
an electrically conductive coupler connecting the magnetic portion on the body to the magnetic portion of at least one tine of the at least one pair of tines.

2. The magnetic grapple of claim 1 wherein the magnetic portion on each tine of the at least one pair of tines is at least partially surrounded by a protective material.

3. The magnetic grapple of claim 1 wherein the magnetic portion on the body and each tine of the at least one pair of tines is an electromagnet.

4. The magnetic grapple of claim 1 wherein the magnetic portion on the body is a magnetic coil.

5. The magnetic grapple of claim 4 wherein the magnetic coil is dimensioned to contain an aperture.

6. The magnetic grapple of claim 5 wherein the body is dimensioned to have a flange portion and a protruding portion, the protruding portion extending through and engaging the aperture in the magnetic coil.

7. The magnetic grapple of claim 6 wherein the body contributes to generating a magnetic field oriented such that a first magnetic pole is located at the protruding portion and an opposite magnetic relative to the first magnetic pole is located at the flange portion.

8. The magnetic grapple of claim 1 wherein each tine of the at least one pair of tines is comprised of:
a magnetic core;
a magnetic coil on the magnetic core located a predetermined distance from the pivot end; and
a non-magnetic tine body at least partially surrounding the magnetic core.

9. The magnetic grapple of claim 8 further comprising a controller for opening and closing the tines of the grapple.

10. The magnetic grapple of claim 8 further comprising a controller for operating the magnetic portion on the body and the magnetic portions on each tine of the at least one pair of tines.

11. The magnetic grapple of claim 10 wherein the controller is capable of controlling the magnetic portion on the body separately from the magnetic portion on each tine of the at least one pair of tines.

12. The magnetic grapple of claim 10 further comprising a controller for operating the at least one pair of tines opened and closed.

13. The magnetic grapple of claim 8 wherein the electrically conductive coupler causes the magnetic portion on the body to operate in combination with the magnetic portion on each tine of the at least one pair of tines.

14. The magnetic grapple of claim 8 wherein the magnetic portion of the body and the magnetic portions of each tine of the at least one pair of tines are electrically wired in a series.

15. The magnetic grapple of claim 8 wherein a unitary magnetic field is generated having a first magnetic pole at the terminal end of each tine of the at least one pair of tines and an opposite magnetic pole relative to the first magnetic pole located at the protrusion portion of the body.

16. The magnetic grapple of claim 8 wherein a plurality of similarly oriented magnetic fields are generated on each tine of the at least one pair of tines, the magnetic fields having a first magnetic pole at the terminal end of each tine of the at least one pair of tines and second magnetic pole proximate to the predetermined distance from the pivot end of each tine of the at least one pair of tines.

17. The magnetic grapple of claim 16 wherein the plurality of similarly oriented magnetic fields each have an additional second magnetic pole at the protrusion portion of the body.

18. The magnetic grapple of claim 17 wherein the relative strengths of the similarly oriented magnetic fields differ between the magnetic field generated between the first magnetic pole and the second magnetic pole and the magnetic field generated between the first magnetic pole and the additional second magnetic pole.

19. The magnetic grapple of claim 18 wherein the relative strengths of the similarly oriented magnetic fields generated between the first magnetic pole and the second magnetic pole and the first magnetic pole and the additional second magnetic pole reverse as the magnetic grapple is operated from an open position to a closed position.

20. A magnetic grapple comprising:
means for grasping materials means for supporting the grasping means;
means for moveably coupling the grasping means to the supporting means; and
means for generating at least one magnetic field within the grasping means wherein the at least one magnetic field is oriented such that a first magnetic pole is located at a terminal end of the grasping means and an opposite magnetic pole relative to the first magnetic pole is located central to the grasping means.

21. The magnetic grapple of claim 18 wherein the magnetic field generated within the grasping means is a unitary magnetic field between the grasping means and the supporting means.

22. A system for handling materials comprising:
a magnetic grapple having at least a body, a magnetic portion on the body, at least one pair of tines, a magnetic portion on at least one of the at least one pairs of tines and an electrically conductive coupler connecting the magnetic portion on the body to the at least one magnetic portion on at least one tine of the at least one pair of tines;
a hoist for positioning the magnetic grapple proximate to a material to be handled; and
a coupler for coupling the magnetic grapple to the hoist.

23. A combined magneto-mechanical method for handling materials, said method comprising the steps of:
obtaining a magneto-mechanical device;
placing the device proximate to a quantity of material;
operating the magneto-mechanical device by engaging the magnetic structures, mechanically closing or opening the device, or performing both functions in combination with one another; and
moving the magneto-mechanical device containing material away from the quantity of material.

24. A method for generating a movable magnetic field around at least one object, said method comprising the steps of:
obtaining a device having at least a pair of moveable electromagnets, pivotally coupled to a non-pivotal electromagnet;
placing the device proximate to a quantity of material;
operating the device to place the moveable electromagnets below at least a portion of the quantity of material;
engaging the electromagnets of the device; and
moving the device containing material away from the quantity of material.
